(19) United States
(12) Patent Application Publication
(10) Pub. No.: US 2011/0173225 A1
(43) Pub. Date: Jul. 14, 2011

(54) LEARNING MANAGEMENT SYSTEM PORTAL

(76) Inventors: Michael James Stahl, Calabasas, CA (US); Stephen Mills Foreman, Agoura Hills, CA (US); Thomas Bertram Tarbert, Tucson, AZ (US)

(21) Appl. No.: 13/006,326

(22) Filed: Jan. 13, 2011

Related U.S. Application Data
(60) Provisional application No. 61/294,816, filed on Jan. 13, 2010.

(51) Int. Cl. G06F 17/30

(52) U.S. Cl. 707/769; 707/E17.014

(57) ABSTRACT

In embodiments of the present invention improved capabilities are described for using a Learning Management System Portal (LMS Portal) to develop learning content, manage learning content, search learning content, distribute and publish, and sell learning content to users of the LMS Portal or third parties that may be associated with the LMS Portal. The LMS Portal may include a learning content management system (LCM System). The LCM System may enable multiple users and/or developers to create, store, aggregate or revise, manage, and publish, distribute, and sell learning content for use within the LMS Portal, and aggregate learning content that is available from other sources through the LMS Portal. The LMS Portal may be further associated with a plurality of LCM system modules, operating within a plurality of LCM systems, at least some of which are operated independently of the LMS Portal, such as LCM system modules that are operated by third party learning content providers.

### CROSS-REFERENCE TO RELATED APPLICATIONS

This application claims the benefit of the following commonly-owned U.S. Provisional Patent Applications, each of which is incorporated herein by reference in its entirety: App. No. 61/294,816 filed on Jan. 13, 2010, and entitled “LEARNING MANAGEMENT SYSTEM PORTAL.”

### BACKGROUND

### Field

The invention is related to learning management systems, and methods and systems for the creation, syndication and distribution of learning content.

### SUMMARY

In embodiments, the present invention may provide a method and system for receiving a query from a client device at an Internet-based learning management system portal, wherein the query relates to learning content subject matter, searching a plurality of learning management systems based at least in part on the received query, and presenting a list of learning content that is relevant to the query, wherein the list enables a user to link to each of the plurality of learning management systems in which a relevant learning content is located. A user of the learning management system portal may access an item of learning content presented within the list and download the item of learning content to the client device.

Accessing an item of learning content using the learning management system portal may require a user to submit a credential to the learning management system portal. A credential may include, but is not limited to, a password, a customer number, a student ID, or some other type of credential.

Accessing an item of learning content may require a user to submit a payment to the learning management system portal. Payment may be automatically deducted from an account that is associated with the learning management system portal.

Accessing an item of learning content may require a user to accept a license term governing the usage of the item of learning content. Concurrent to downloading an item of learning content, an item of sponsored content may be downloaded to the client device. Sponsored content may include, but is not limited to, an advertisement and/or a second item of learning content. The second item of learning content may be relevant to the query. The second item of learning content may be only partially presented to the user and may require that the user make a payment in order for the full second item of learning content to be presented to the user.

In embodiments, a client device may be a personal computer, laptop computer, tablet computer, mobile communication facility, electronic book reading device, television, GPS navigation aid, or some other type of client device. A mobile communication facility may include, but is not limited to, a cellular phone, a GSM phone, a smartphone, or some other type of mobile communication facility.

In embodiments, a query may include, but is not limited to, a keyword, a category, a course name, an instructor's name, an organization name, or some other type of query data.

In embodiments, the relevance of learning content to a query may be based at least in part on contextual data associated with the learning content. Contextual data may include, but is not limited to, a keyword.

In embodiments, the relevance of learning content to a query may be based at least in part on data associated with the user. Data associated with the user may be stored in a user profile. A stored user profile may be associated with a user account that is further associated with the learning management system portal.

In embodiments, a query may be received from a client device at an Internet-based learning management system portal, wherein the query relates to learning content subject matter. Based at least in part on the received query, a plurality of learning management systems may be searched. A list of learning content that is relevant to the query may be presented, wherein the list enables a user to link to each of the plurality of learning management systems in which a relevant learning content is located. The user may access and download a first item of learning content that is presented within the list. The user may access and download a second item of learning content that is presented within the list. The user may combine the first and second items of learning content to create an aggregated item of learning content, and store the aggregated item of learning content on a server that is associated with the learning management system portal.

In embodiments, an aggregated item of learning content may be syndicated to a second user of the learning management system. Syndication may require the second user to make a payment in order to view the aggregated item of learning content. Syndication may combine the aggregated item of learning content with a sponsored content. The learning management system portal may be paid a fee upon each impression of the sponsored content presented to a plurality of users.

In embodiments, a query may be received from a client device at an Internet-based learning management system portal, wherein the query relates to learning content subject matter. Based at least in part on the received query, a plurality of learning management systems may be searched. A list of courses that are relevant to the query may be presented, wherein the list enables a user to link to each of the plurality of learning management systems in which a relevant course is located. The user may access and download a first course that is presented within the list. The user may access and download a second course that is presented within the list. The user may combine the first and second courses to create a curriculum, and store the curriculum on a server that is associated with the learning management system portal.

In embodiments, a curriculum may be syndicated to a second user of the learning management system. Syndication may require the second user to make a payment in order to view the curriculum. Syndication may combine the curriculum with a sponsored content. The learning management system portal may be paid a fee upon each impression of the sponsored content presented to a plurality of users.

### BRIEF DESCRIPTION OF THE FIGURES

The invention and the following detailed description of certain embodiments thereof may be understood by reference to the following figures:

FIG. 1 depicts a simplified architecture including the learning management system portal with associated independent learning content management system modules.

FIG. 2 illustrates the learning management system portal, a subset of its enabled functionalities, and means for a user to access learning content from the learning management system portal.

FIG. 3 illustrates an embodiment of the learning management system portal in which content may be syndicated to third party content users.

FIG. 4 illustrates an embodiment of the learning management system portal enabling content to be syndicated to a user based at least in part on a relevancy derived from learning content contextual data and user data.

FIG. 5 illustrates a user query formation facility that may be associated with the learning management system portal.

FIG. 6 illustrates electronic content tagging that may be associated with the learning management system portal.

FIG. 7 illustrates a simplified revenue distribution model associated with the learning management system portal.

### DETAILED DESCRIPTION

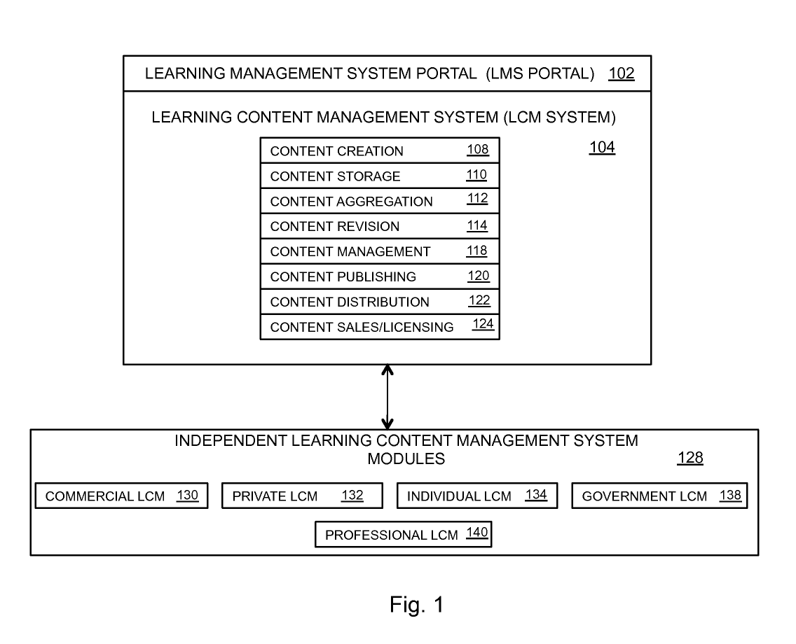

In embodiments of the present invention, as shown in FIG. 1, a Learning Management System Portal (LMS Portal) 102 is provided that is enabled to develop and create learning content 108, store 110, aggregate 112, and revise learning content 114, as well as manage 118, search, distribute 122, publish 120, and license or sell 124 learning content to users of the LMS Portal or third parties that may be associated with the LMS Portal. The LMS Portal may include a learning content management system (LCM System) 104. The LCM System may enable multiple users and/or developers to create, store, aggregate or revise, manage, and publish, distribute, and sell learning content for use within the LMS Portal, and aggregate learning content that is available from other sources, such as independent learning content management systems and/or independent learning management systems, through the LMS Portal. The LMS Portal may be further associated with a plurality of independent LCM system modules 128, operating within a plurality of LCM systems, at least some of which are operated independently of the LMS Portal, such as LCM system modules 128 that are operated by third party learning content providers. Third party content providers may include, but are not limited to, commercial LCM systems 130 (e.g., a corporation's IT help system), private LCM systems 132 (e.g., a home-schooling network, private university, religious organization), individual LCM systems 134 (e.g., hobbyist or freelancer), government LCM systems 138 (e.g., registry of motor vehicles), LCMs system affiliated with professional accreditation organizations 140 (e.g., entities offering continuing medical education), or some other type of third party provider.

The LMS Portal, as described herein, may be a horizontally organized LMS portal, a vertically organized LMS portal, a portal combining aspects of horizontal and vertical organization, or consist of some other type of portal organization. In an example, a horizontally organized LMS Portal may include an LMS Portal that provides a plurality of learning content providers (e.g., learning institutions, corporations, individuals), a plurality of content types of genres (e.g., software programming, professional accreditation, wood carving), a plurality of languages (e.g., English, Spanish, German), or some other plurality of learning content and/or learning content sources. In an example, a vertically organized LMS Portal may include an LMS Portal that includes learning content from a single source (e.g., a single individual or university), a single subject, or narrowly focused subject (e.g., the Spanish language, history, and culture), and the like. In yet another embodiment, an LMS Portal may combine aspects of horizontal and vertical organization, for example, the LMS Portal may incorporate a horizontal breadth of subject matter and learning genres (e.g., Chilean cuisine, jewelry making, state history), but within each learning genre, or subset of learning genres, provide access to vertically organized learning management system content (e.g., that made available by a State Historical Association). In embodiments, the horizontal or vertical organization of the LMS Portal may be user-defined so that an individual can select from among the plurality of content and create a unique user LMS module, within the LMS Portal, that pertains to that unique user's interests, and which contains a user-selected set of learning content that may be derived from a plurality of content providers. The user may then publish or otherwise make this LMS module available to other users of the LMS Portal and/or publish or otherwise make available this LMS module to users outside of the LMS Portal, such as users of other LMS systems.

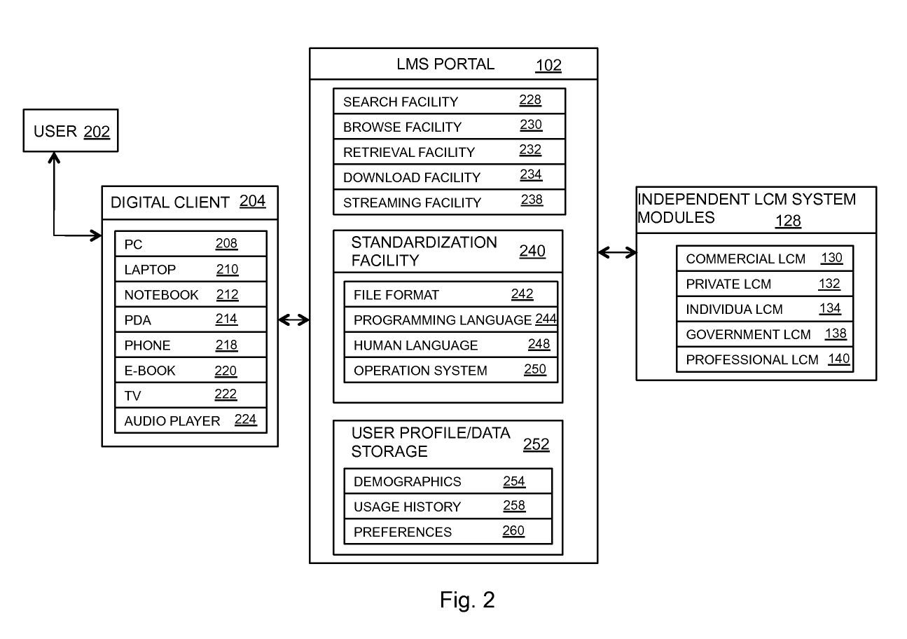

Referring to FIG. 2, in embodiments, the LMS Portal 102 may enable users to search 228, browse 230, retrieve 232, download 234, stream 238, use, and/or interact with learning content that is published from a plurality of sources that are not affiliated with the operators of the LMS Portal, and which is published in a plurality of file formats 242, programming languages 244, human languages 248, operating systems 250, and the like. The LMS Portal may provide for the standardization 240 of the plurality of file formats, programming languages, human languages, operating systems, and the like, in an automated process and/or in a user-defined process. For example, a user wanting to aggregate a learning module for himself relating to “Woodcut Relief Printing” using the LMS Portal, may find, through the LMS Portal, a first content that is an audio file in the “.wav” format describing the history of woodcut printing, a second content that is a text file (“.txt”) in Japanese describing how to prepare a woodblock for carving, and three images of carved woodblocks that are ready to print, one of which is a “.gif” file, a second a “.jpg” file, and the third a “.tiff” file. Continuing the example, in one embodiment, the LMS Portal may have stored user profile information 252 relating to the user and at least the user's demographic data 254, usage history 258, and content preferences 260 which shows that this particular user prefers all audio files to be in the “.mp3” format, all text-based files to be in the “.doc” format, and in the English language, and all image files in the “.jpg” format. Based on this information, the LMS Portal may automatically convert the learning content requested by the user to the user's preferred formats. In another embodiment, the LMS Portal may provide for automated conversion of file formats, and the like, based on a default setting. In an example, this default setting may be based at least in part on information known about the user, but that is not stored in a user account or profile, such as the IP address of the computer from which the content request is placed. This IP address may be used to make assumptions about user preferences, such as a United States-based IP address indicating a probable preference for learning content in the English language, and so forth. In another embodiment, a user's prior downloads of, or interactions with learning content and its related formats may be used by the LMS Portal to derive user-preferred format settings, and the LMS Portal may use this information to alter file settings without receiving further user inputs.

In embodiments, the LMS Portal may be based on a developmental platform including, but not limited to, Java/J2EE architecture, Microsoft .NET, PHP, open-source, or some other development platform. The LMS portal may be further associated with a database or plurality of databases, each of which may be integrated and/or associated with the LMS Portal as described herein. The LMS Portal may provide access to and links to other content, applications, programs, or other digital facilities. The LMS Portal may enable the use of, and/or be associated with, distributed applications. Distributed applications may include, but are not limited to, distributed computing systems, distributed programming, the use of distributed algorithms, cluster computing or some other type of distributed embodiment.

In embodiments, the LMS Portal may be associated with middleware applications. Middleware applications may reside within the LMS Portal, within LMS's that are associated with the LMS Portal, or within a third party system that is unaffiliated with the LMS Portal. The middleware, as described herein, may provide for interoperability between a plurality of client operating systems using the LMS Portal, and/or a plurality of operating systems in use at third party systems interacted with by users of the LMS Portal.

In embodiments, the LMS Portal may conform to a standard including, but not limited to, the Web Services for Remote Portlets v.1, the Web Services for Remote Portlets v.2, the Java Portlet Definition Standard, the Java Portlet Definition Standard v.2, or some other type of portal, or portal-related standard.

Still referring to FIG. 2, the LMS Portal may be accessed by a user 202 and interacted with using a digital client 204. A digital client may include, but is not limited to, a personal computer 208, a laptop computer 210, a digital notebook 212, a PDA 214, a phone 218 (e.g., telephone, a cellular phone, a GSM phone, a smartphone), electronic book 220, audio player 224 (e.g., iPod, mp3 player, portable video device, portable TV, or some other type of digital client.

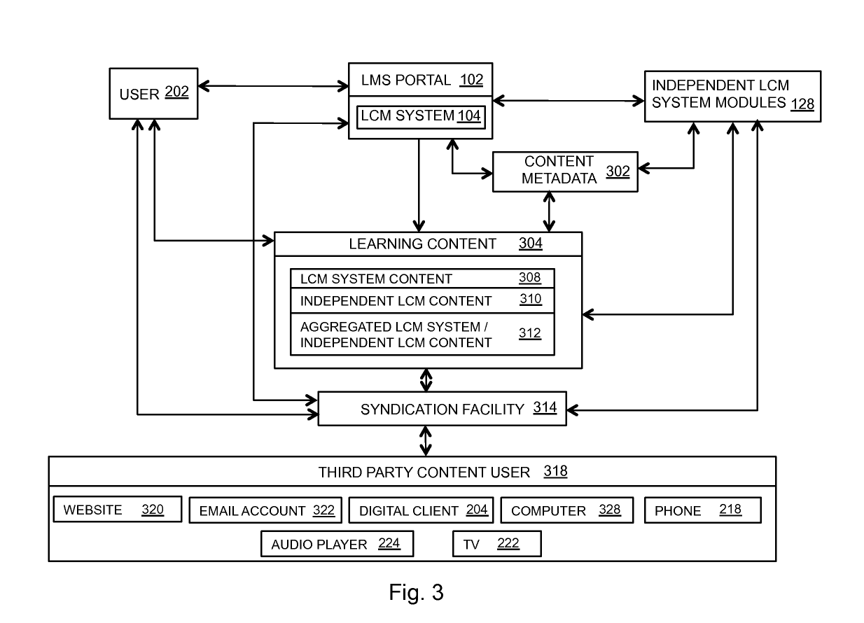

Referring to FIG. 3, in embodiments, the learning content that is available through the LMS Portal 102, created within the LMS Portal (e.g., using the LCM System 104), or associated with the LMS Portal, may be syndicated to other users using a syndication facility 314 that is associated with the LMS Portal, including third party content users 318. The syndication may be automated, initiated individually by the LMS Portal operator(s), and/or initiated by the user 202 or creator of learning content 304. The syndication of learning content 304 may be to at least a website 320, an email account 322, a digital client device 204 (such as a phone or notebook computer), computer 328, phone 218, audio player 224, television 222, or some other location or device.

In embodiments, the learning content 304 that is available through the LMS Portal 102, created within the LMS Portal (e.g., using the LCM System 104), or associated with the LMS Portal 102, may be syndicated to other LCM systems 128 and embedded in the content of the other LCM systems, or non-LCM systems, such as websites 320. The syndication may be automated by the LMS Portal, may be done at the request of a user of the LMS Portal, may be requested by a third party service provider, such as an LCM system that is independent of the LMS Portal, or carried out using some other methodology. Learning content that is available within, or in association with, the LMS Portal may be associated with content metadata 302 indicating the source of the content, the author(s), the location from which it derives, the subject matter, language, technology requirements for viewing, cost, fees for viewing, number of times the content may be viewed by users purchasing the content, authorization code (e.g., a unique alpha-numeric code) or some other type of metadata. The metadata 302 associated with the learning content may be stored in a database within, or associated with, the LMS Portal. Learning content may include, but is not limited to LCM system content 304 from the LMS Portal, independent LCM content (including independent LMS content) 310, and/or aggregated content consisting of LCM content from the LMS Portal and independent LCM content 312.

For example, a music Professor may be an expert on the construction, maintenance, and upkeep of saxophones. Using the LCM System within the LMS Portal, and the authoring tools and techniques as described herein, the Professor may create a number of courses, including a course titled “Buying your First Saxophone.” During the creation of the course, or in at a time following creation of the course, the Professor may use the LCM System to associate metadata with the course including, but not limited to, the genre of the course, its time length, the types of files included in the course (e.g., text and image files), the course's creator, the creator's account (including a financial account that may receive funds, such as an EFT-enabled account), or some other type of metadata. Continuing the example, a code representing this metadata, such as an alpha-numeric code, may be associated with the learning content file(s) so that user interactions with the content may be registered, recorded, and stored in a database within, or associated with, the LMS Portal. This may facilitate tracking who is using a content, which content is being used, what revenue is owed by a user of the content, to which account that revenue should be provided, and so forth. Still continuing the example, Music Store Owner, a proprietor of a failing music store may wish to increase saxophone sales by drawing more page views of his store's website by offering potential customers educational content. The Owner may find the Professor's course, “Buying your First Saxophone,” within the LMS Portal and want to feature it on his company's website. The LMS Portal may enable the Owner to copy the course, and at least a portion of the metadata associated with the course (e.g., an alpha-numeric tracking code). The course may be further associated with HTML, or other code that enables the Owner to insert the course files into the HTML or other code that is in operation at his website, without requiring the Owner to perform any additional software programming. Based at least in part on the alpha-numeric code that is associated with the course files, the Professor may have his account credited with revenue based upon criteria that the Professor specifies, for example $X per course viewing, $Y per posting the course to the website for one-month, or some other revenue criterion. The funds may be automatically credited to the Professor's account using electronic funds transfer, a third party payment service, such as PayPal, or some other means of funds transfer. In another embodiment, the Professor may make his course content available to other users, like the Owner, but require only a minimum payment for use of the course content, and permit users like the Owner to charge whatever fee the market will bear, and to keep the funds collected in excess of the payment required by the Professor. In yet another embodiment, the Owner may choose to package the Professor's content with content that is provided by other music experts, and offer it as an introductory course to his customers, effectively making him a reseller of others' learning content. In yet another embodiment, the Owner may use the Professor's content, but brand the courses under the Owner's name, and share course revenues between the Owner and the Professor. For each type of learning content exchange, barter, sale, or file share, as described herein, the LMS Portal may charge a fee, or fee sharing arrangement using any of the means of revenue recognition understood by one skilled in the art, including but not limited to those that are described herein.

In embodiments, the LMS Portal may provide a forum (e.g., email, chat, or other correspondence) for those users with learning content, but few customers/users, to find and communicate with parties having pools of customers/users looking for content, but no content of their own to offer the customers/users. For example, a proprietor of a garden nursery may have many customers that inquire about bonsai and the propagation of bonsai plants. The proprietor may seek out experts in bonsai using the LMS Portal and, based at least in part on the use of the forum, find individuals, horticulturalists, or others with an expertise in bonsai propagation, but who have only limited access to persons seeking their knowledge. The LMS Portal may provide the means, methods and systems for the proprietor of the garden nursery to find the bonsai experts, search and browse their learning content, and select learning content to include on the garden nursery website.

In embodiments, the LMS Portal may provide a forum (e.g., email, chat, or other correspondence) for those users seeking a type learning content to post requests for learning content, courses, and the like. A bidding facility may be provided in association with the LMS Portal that enables learning content providers to bid on creating learning content to satisfy the need(s) of parties that have posted learning content requests within the LMS Portal forum.

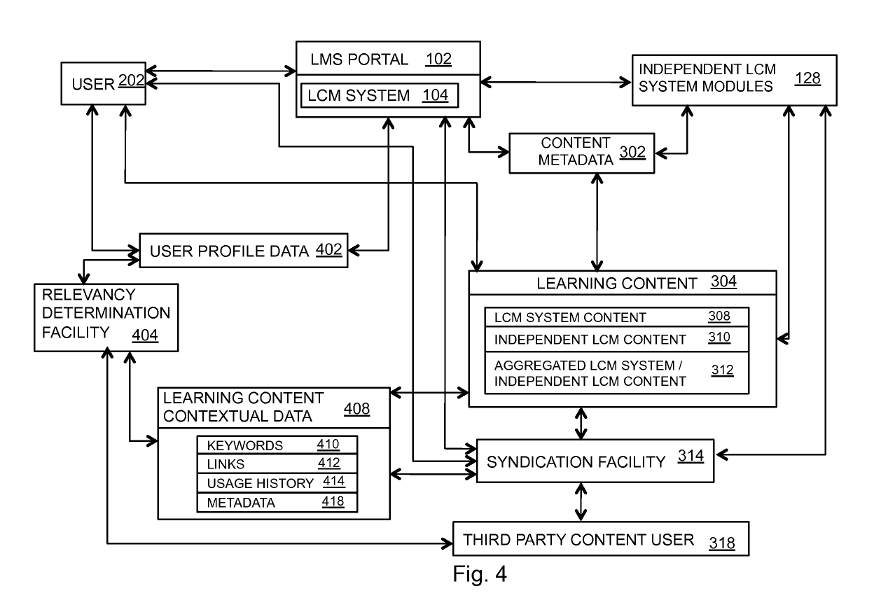

Referring to FIG. 4, in embodiments, the learning content 304 that is available through the LMS Portal 102, created within the LMS Portal, or associated with the LMS Portal may be syndicated to other users using a syndication facility 314 based at least in part on using contextual information 408 associated with the learning content 304 in order to determine the relevancy, using a relevancy determination facility 404, of learning content 304 to a user-specified criterion, such as a keyword 410, links 412 associated with or within the learning content, usage history of the content 414, and/or metadata 418. Relevancy may be based at least in part on a relevancy between learning content contextual data 408 and user profile data 402. In an example, a user-specified criterion may be derived by the LMS Portal based at least in part on the user's prior usage of, and behaviors within, the LMS Portal. For example, a user of the LMS Portal may have previously searched, retrieved, used, or interacted with learning content bearing the titles: “Iambic Pentameter for Fools,” and “Wallace Stevens on Your Lunch Break.” An automated program running within the LMS Portal or affiliated with the LMS Portal may recognize keywords, metadata, or other material within this content that indicates a relevance to the learning content genre “Poetry.” Based at least in part on this, the user may be associated with a user profile datum/data indicating that the user is interested in poetry. A second user that has learning content relating to poetry may search for and select this user to receive a syndication feed of her learning content through the LMS Portal. The selection of the user to whom to syndicate content based on the user profile datum/datum indicating an interest in poetry may be automated, initiated individually by the LMS Portal operator(s), and/or initiated by the user or creator of learning content that is available within or associated with the LMS Portal. Access to the user profile data indicating an interest in poetry may be a fee based service that is offered to the second user.

Contextual information 408 that may be associated with learning content 304 may also include keywords, terms, or phases located within or associated with the learning content, the inbound links to the learning content, the outbound links from the learning content, click patterns and clickthroughs associated with prior use of the learning content (including click patterns and clickthroughs associated with sponsored content appearing in association with the learning content), metadata, learning content usage patterns including time, duration, depth and frequency of learning content usage, the learning content's origination host, genre(s) relating to the learning content, and other indicia of learning content context.

The relevancy of the contextual information associated with a learning content may be indicated through the use of a relevancy score. The relevancy score may be a numerical summary of the statistical association between, for example, contextual learning content parameters (e.g., genre of learning content) and user parameters (e.g., genres of learning content previously downloaded by user). The relevancy score may be a proprietary score assigned to a learning content by the LMS Portal operator, or third party service provider that is associated with the LMS Portal. The relevancy scores of a syndicated learning content may be stored in a learning content relevance dictionary.

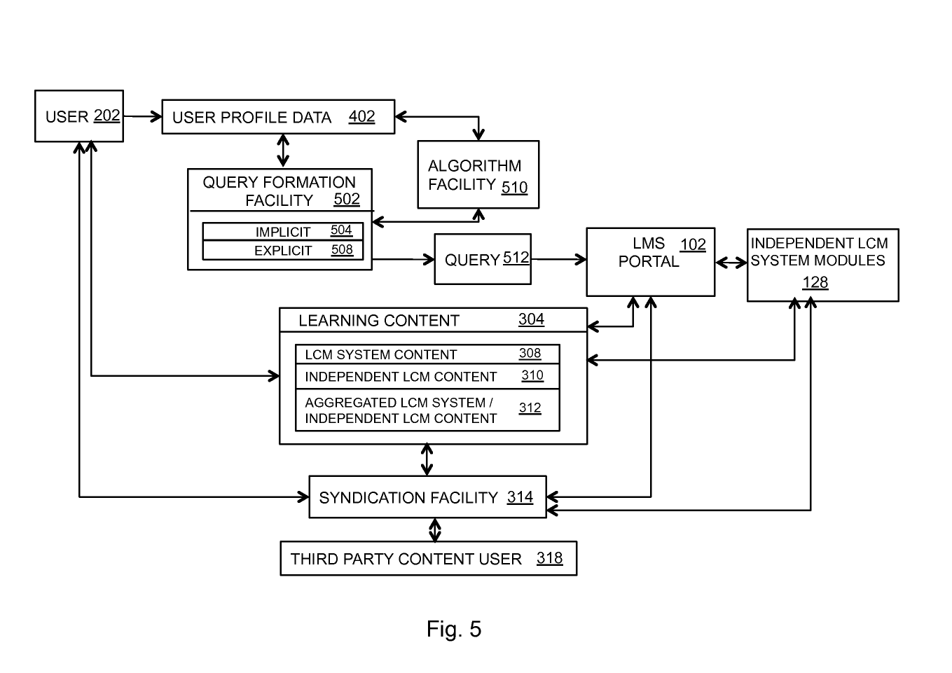

Referring to FIG. 5, in embodiments, usage patterns may be obtained from a database of user profile data 402 and/or metadata relating to users of the LMS Portal 102. A wide range of usage patterns may be used to assist with formation of queries 502 (implicit 504 and explicit 508) and with retrieval and organization of learning content search results, such as that presented to a user 202 of the LMS Portal 102 that is searching for learning content 304, courses, and the like. An algorithm facility 510 may include one or more modules or engines suitable for analyzing usage patterns to assist with such functions in forming a query 512. For example, an algorithm facility 510 may analyze usage patterns based on time of day, day of week, day of month, day of year, work day patterns, holiday patterns, time of hour, patterns surrounding transactions, patterns surrounding incoming and outgoing learning content, patterns of clicks and clickthroughs, patterns of communications (e.g., Internet, email and chat), and any other patterns that can be discerned from data that is used within, or in association with the LMS Portal. Usage patterns may be analyzed using various predictive algorithms, such as regression techniques (least squares and the like), neural net algorithms, learning engines, random walks, Monte Carlo simulations, and others as described herein.

In embodiments, an API, or plurality of API's may be provided to enable and facilitate the management and use of user data, such as user profiles, and the operation of syndication within or in association with the LMS Portal.

In embodiments, the determination of relevance, relevancy, associations, correspondence, and other measures of correlation and relationships between learning content, users, and metadata associated with both, as described herein, may be made based at least in part on statistical analysis. Statistical analysis may include, but is not limited to techniques such as liner regression, logistic regression, decision tree analysis, Bayes techniques (including naäve Bayes), K nearest neighbors analysis, collaborative filtering, data mining, and other statistical techniques may be used.

In an example, linear regression analysis may be used to determine the relationship between one or more independent variables, such as user profile data, and another dependent variable, such as a datum associated with a learning content (e.g., author name, genre, and the like), and modeled by a least squares function, called a linear regression equation. This function is a linear combination of one or more model parameters, called regression coefficients.

In another example, Bayes theorem may be used to analyze user profile and/or learning content data, such as contextual data that is associated with learning content, data relating to an LMS Portal user, or some other type of data used within the LMS Portal. Using Bayes thereom, conditional probabilities may be assigned to, for example, user profile variables, where the probabilities estimate the likelihood of a learning content purchase and may based at least in part on prior observations of the users' interactions with learning content. Naïve Bayes classifiers may also be used to analyze LMS Portal data. A naive Bayes classifier is a probabilistic classifier based on applying Bayes' theorem with strong (naive) independence assumptions. A naive Bayes classifier assumes that the presence (or lack of presence) of a particular feature of a class is unrelated to the presence (or lack of presence) of any other feature. For example, an LMS Portal user may be classified in a user profile as interested in jazz learning content if he has previously searched for, retrieved, downloaded, used, and/or interacted with jazz learning content, and the like. A Bayes classifier may consider properties, such as prior use of jazz learning content, prior purchases of jazz learning content, searches for jazz learning content and the like to independently contribute to the probability that this user is interested in jazz learning content. Once a classification is assigned within the user profile (e.g., User X=jazzfan), the user's information may be stored and shared by the LMS Portal (e.g., sharing the data with other users of the LMS Portal, sending the data to an ad server where the classification “jazz fan” may be used to select jazz-related sponsored content to deliver to the user is association with the delivery and presentation of jazz-, or other subject-related content). A single user profile may include a plurality of classifiers. For example, the jazz fan's user profile may also include classifiers indicating that the user is a “native English speaker,” or a “chiropractor,” and so forth, using the data that is associated with the user's actions and behaviors within the LMS Portal, and any other data sources as described herein. An advantage of the naive Bayes classifier is that it may require a small amount of training data to estimate the parameters (means and variances of the variables) necessary for classification. Because independent variables are assumed, only the variances of the variables for each class need to be determined and not the entire covariance matrix. This characteristic of naïve Bayes may enable the classification.

In embodiments, a behavioral data analysis algorithm may be used for developing behavioral profiles for LMS Portal users. Behavioral profiles may then be used for targeting advertisements and other content to the LMS Portal users. A behavioral profile may include a summary of a user's activity within the LMS Portal, including the types of content and applications accessed, and other behavioral properties. The user's activity summary may include searches, browses, purchases, clicks, impressions with no response, or some other activity as described herein. The behavioral properties may be summarized as continuous interest scores of a learning content category, or some other property. Continuous frequency scores and continuous recency scores (e.g., how recently the activity occurred) may be considered as behavioral properties for use in constructing a behavioral profile. A user's activity summary and the behavioral properties may be categorized using the analytic techniques as described herein (e.g., naïve Bayes classifiers). Learning content data, and its characteristics, and sponsored content that may be associated with the presentation of learning content to a user (e.g., an advertisement), may also be used for the generation of a behavioral profile. For example, data such as advertisement identity, ad tag, user identity, advertisement spot identity, date, and user response may be used. In addition, content categories may be used for targeting learning content and/or advertisements based on a behavioral profile, or portion of a behavioral profile. Further, content categories may be associated with each search, browse, download, purchase, or other online behavioral activities and/or transactions.

A program of automatically syndicating learning content with the user base of the LMS Portal, or to users outside of the LMS Portal, may be based at least in part upon the relevance of contextual data associated with the learning content and information know about a user, or group of users (e.g., user profile data, as described herein). The automation of syndicating learning content may be based at least in part on associating metadata with the learning content. Contained within the metadata may be information regarding the relevance of the learning content to various users and/or user groups. An example of only one of the many examples of how a metadata may contain relevance information may include: metadata indicating the relevance of a learning content to a user group's LMS website (e.g., “University X LMS System Users”), metadata indicating the average relevancy score that is associated with a learning content purchase by a user from a given user category, and the like.

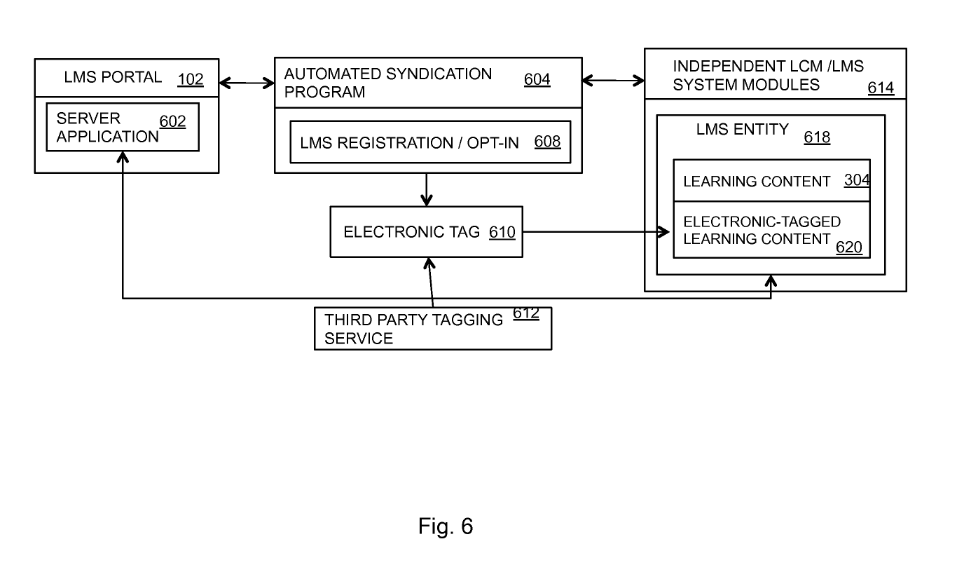

Referring to FIG. 6, in embodiments, an independent LCM and/or LMS entity 618 within a plurality of independent LCM and/or LMS system modules 614, associated with the LMS Portal may be able to opt into an automated syndication program 604. The registration and/or opt-in 608 may be done through the LMS Portal 102, through a self-service website, through an entity conducting the automated syndication program 604, through a ground mailed solicitation, phone call solicitation, through a website tag, and the like. Once an LMS entity 618 has opted into the program, the automated syndication program 604 may associate an electronic tag 610 with learning content that is available within the LMS entity's system in order to create an electronic-tagged learning content 620 and commence the automated syndication through the LMS Portal 102.

In embodiments, a server application 602, or plurality of server applications, designed for retrieving learning content 304 through the LMS Portal 102 may read LMS websites, syndication feeds, or other content and/or data looking for the LMS Portal syndication indication tag. In another embodiment, the LMS Portal may be associated with a database or plurality of databases in which the URLs or other data corresponding to and identifying the LMS entities that have requested to participate (opt-in). Once the server(s) confirms the LMS site is to receive and/or provide syndicated learning content, the server may automatically provide learning content to the website, and/or receive learning content from the website. In embodiments, the tag may be provided by any number of different entities or sources. For example, the tag may be provided by the LMS Portal 102, a third party tagging service 612, or some other tagging provider. In embodiments, the format of the tag may be known and an LMS site administrator may insert the tag 610.

In embodiments, learning content that is syndicated to an LMS website, or other site, may include a search box that may allow for searching the learning content alone or a set of content broader than the learning content alone.

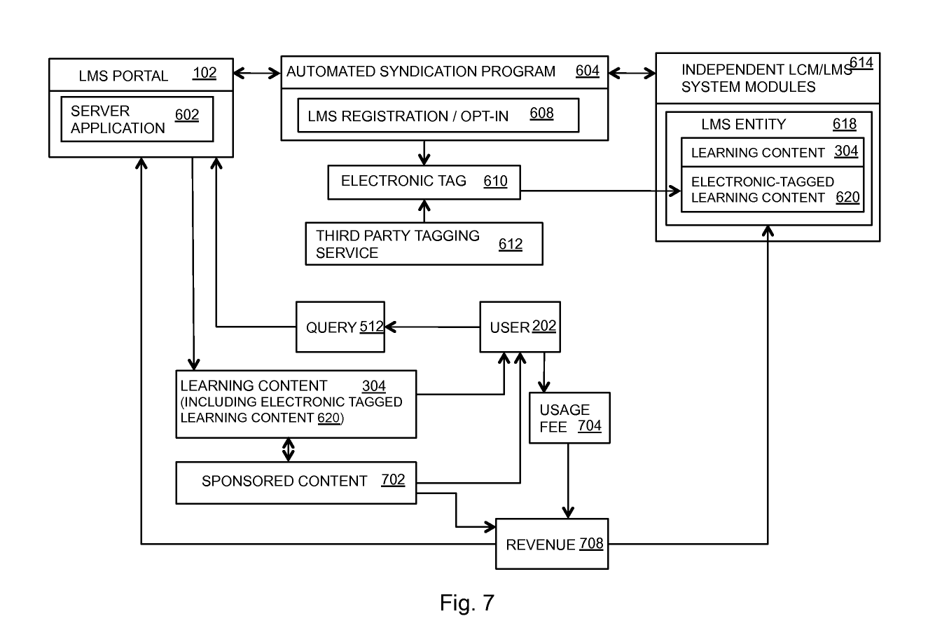

Referring to FIG. 7, the automated LMS syndication program 604 may derive revenue 708, for example through a flat fee, revenue sharing, or no-fee service program offered to an LMS entity or plurality of LMS entities. In embodiments, parties such as a user 202 may be required to pay a usage fee 704 to access, create, aggregate, and/or interact with content. In another embodiment, sponsored content 702 such as an advertisement may be presented to a user 202 in conjunction with the presentation of learning content 304. The owner of the sponsored content, or other interested party, may be required to pay a fee for the right to present the sponsored content 702 to the user. This revenue 708 may be shared among the LMS Portal 102 and/or the independent LCM/LMS system modules 614 based at least in part on the party responsible for creating the learning content 304 that is viewed by the user 202, and/or the LCM or LMS system that is responsible for presenting the content to the user 202. The automated LMS syndication program may involve a split fee service program offered to an LMS entity in which the LMS entity shares revenues with the LMS Portal resulting from the LMS Portal users' interaction with shared learning content, sponsored content revenues associated with the presentation of learning content, or some other revenue source associated with the use and distribution of learning content by the LMS Portal. Fees may be derived from sponsors of learning content participating in the automated syndication program. Fees may be derived from the sponsors of learning content, a competitive bidding process, auction, flat fee service, or the like. The fee structure and bidding may be based at least in part on a relevancy score associated with a learning content.

In embodiments, a user's aggregation of learning content within the LMS Portal may be associated with a fee whereby the creator of the learning content receives compensation and/or the operator of the LMS Portal receives compensation. The compensation and distribution of funds caused by the user's retrieval, use of, or interaction with the learning content may be automated by the LMS Portal or a third party service provider that is associated with the LMS Portal. The automated distribution of funds may deduct the funds from an account (e.g., a checking, credit card, or other electronic fund transfer-enabled account) that the user has with the LMS Portal, and/or from an account external to the LMS Portal. In one embodiment, the funds may be distributed from the user's account and into an account that is associated with the creator of the learning content that the user retrieved, used, or interacted with. This account may be an account within the LMS Portal and/or external to the LMS Portal. In another example embodiment, if the user retrieves, uses, or interacts with content that is newly available within the LMS Portal, and for which the LMS Portal operators have no prior interaction or account with the creator of the learning content retrieved, used, or interacted with by the user, the LMS Portal may send the creator of the learning content a solicitation, invitation, promotional offer, or some other form of communication describing the services offered by the LMS Portal, the financial opportunities associated with making the creator's content available within the LMS Portal, a description of an opt-in process for the creator, or some other information relating to the LMS Portal and its operation.

The LMS Portal may derive revenue from sponsored content that is displayed within or in association with the LMS Portal and/or LMS Portal content. The LMS Portal may derive revenue from the sale of courses or course material from within or in association with the LMS Portal and/or LMS Portal content. Course material may include, but is not limited to, electronic course material, physical course material (e.g., lesson books), multimedia material (e.g., video lectures), or some other type of course or educational material. The LMS Portal may derive revenue from the sale of physical goods from within or in association with the LMS Portal and/or LMS Portal content. In an example, the LMS Portal may include a student store in which various physical goods may be purchased, such as supplies related to education, a learning management system, or some other student need. In a simplified example, a user of the LMS Portal may want to store course content on an external hard drive, and may be provided a link within the LMS Portal to visit the student store in which various computer components and peripherals, such as hard drives, may be purchased. The student store may be operated by the LMS Portal or by a third party service.

The LMS Portal may include and/or be associated with a learning content manager (LCM) that may be used to create and share learning content. The LCM may provide for text, audio, image, video, or some other type of formatting. In an example, the LCM may enable users to import text, audio, video, source code, binary code, metadata, or some other type of content into the LCM. This imported material may be used to create learning content. In another example, the LCM may provide users with a WYSIWYG functionality, analogous to a word processor, that includes, but is not limited to, the functionalities of:

View or edit document source code.
HTML editor.
Text editor.
Image editor.
Video editor.
Audio editor.
Language translator.
Preview HTML page.
Select a layout template.
Remove highlighted text.
Copy highlighted text.
Paste text (with or without formatting)
Copy content from, for example, Microsoft Word, and paste into an
HTML editor.
Print an HTML page.
Insert Flash, .swf file, or other file type to a page.
Undo or redo the most recent action taken.
Find a word or phrase within the text of an HTML page.
Find and replace a word or phrase within a text.
Select all of the text in an HTML page.
Remove formatting from highlighted text.
Bold, italic, underscore or [symbol] text.
Superscript or subscript text.
Change the color of text.
Change the background color behind text.
Add numbering or bullets to text.
Increase or decrease the text's indentation.
Justify text (left, centered, right, justified).
Add or remove hyperlink from text.
Upload or insert images into an HTML page.
Insert table. Number of columns or rows, and table width, height, borders,
& alignment may also be set.
Insert divider line (horizontal rule).
Insert video files (mpg, avi, flv, wmv, mov, mp4, or other video file type).
Insert symbols & special characters (trademarks, currency, etc.)
Insert page break.
Insert MP3 files into embedded player
Menu functionality, such as drop down boxes to style specific elements
(such as headings), or set overrides for font face, font size, etc.

In embodiments, the LCM within and/or associated with the LMS Portal may enable the creation of learning content in the form of a course. Course content may be created using tools, as described herein, for combining media (e.g., text, audio, video) obtained from a plurality of sources, including user-created content, intra-LMS Portal content, and extra-LMS Portal content. The LMS Portal may provide users with digital content, such as commonly used digital content including, but not limited to, FAQs, icons, instruction text, logos, test response templates (e.g., multiple choice answer format, essay text answer format, and the like), or some other type of digital content. Course content may be created in the form of text-based pages, audio files, video files, or some combination of text, audio, and video. Individual test questions, or course sections may be associated with content such as other test, audio or video. For example, a course on Contemporary America Cinema may include links to video clips from contemporary American films on a server within or associated with the LMS Portal. In another embodiment, the course content may include links to website content that is external to the LMS Portal and/or LCM System.

In embodiments, an API, or plurality of API's may be provided to enable and facilitate users' creation of course or other educational material and/or users' interactions with course or other educational material.

In embodiments, the LCM within and/or associated with the LMS Portal may enable the creation of learning content that includes gated questions. For example, before advancing to a next question, a next section of a course or text, a user may be required to answer a question or set of questions correctly, spend a predetermined amount of time on a page or viewing a content item, or meet some other requirement.

In embodiments, the LCM within and/or associated with the LMS Portal may enable guided direction and instruction for a user interacting with course and/or testing content. In an example, a user incorrectly completing a test question may be alerted that the material covering the subject matter of the test question is Chapter Six. The user may then be provided a link to the Chapter Six material, be provided a link to download the Chapter Six material for later viewing, be forced to interact with the Chapter Six material (i.e., read the material) before being permitted to carry on with the test, or provided some other instruction relating to the incorrectly answered test question.

In embodiments, a user interacting with material in the LMS Portal and/or LCM System may be provided feedback and reward for courses completed, tests completed, test questions answered correctly, and the like. In an example, a student successfully completing a test, may be rewarded points, a coupon, a rank, a digital certificate, or some other token of achievement indicating that she has mastered that particular content item. The LMS Portal and/or LCM System may enable a user to publicly display the tokens of prior achievements to the other users of the LMS Portal and/or LCM System. The tokens of achievement may provide surrogate measures of user expertise. In another embodiment, these tokens of achievement may form a intra-LMS Portal and/or LCM currency system in which the tokens may be traded, sold, exchanged, or otherwise placed in circulation in exchange for a right, permission, commodity, or some other bargained-for component. For example, a user may embark on a course of instruction in the area of “Thelonius Monk's Chord Structures and Patterns” using the LMS Portal and/or LCM System. Upon completion of the first course, the user may be awarded with a token that provides the user a permission or right, such as a discount towards the purchase of a second course in the same topic area, a free piano lesson redeemable at a music store in the user's local area that has partnered with the LMS Portal, a limited-time offer to try out a different course subject for free, the right to post a publicly displayed opinion or rank of the course completed, or some other permission or right. Tokens may be collected by users and the LMS Portal may calculate a user “expertise” based at least in part on the number of tokens held by a user. For example, a user with 1-5 “jazz tokens” earned from successfully completing jazz-related courses may be classified as a “Jazz Novice,” whereas a user with 75-100 jazz-related tokens may be classified as a “Jazz Expert.” Such user classifications may be publicly displayed and search-enabled so that other users may search for all Jazz Experts that have used the LMS Portal and, for example, find out which jazz-related courses the Jazz Experts have consistently rated as excellent. This may foster intra-Portal expert communities and provide users, through the use of the LMS Portal syndication tools as described herein, to earn revenue based at least in part on their level of expertise and the resulting interest from other users in the experts' learning content.

In embodiments, the LMS Portal and/or LCM System may provide learning content authors customizable templates, “skins,” brandable pages, environments, or other graphic elements for use in their learning content creations.

In embodiments, access to learning content may be associated with access hierarchies, for example, “student,” “teacher,” “administrator,” or some other taxonomy of users.

In embodiments, the LMS Portal may provide a means for users to create a unique user account. The user account may provide demographic information relating the user, usage history, and/or preferences of the user. Usage history and preferences may include, but are not limited to, learning areas of interest (e.g., subject areas or genres), prior education, prior learning content accessed through the LMS Portal, current course enrollment (including LMS Portal enrollment and offline, brick-and-mortar institution enrollment), native language, data relating to client device(s) that the user plans to use to access the LMS Portal, transactions, course content created by the user, or some other type of preference or history data.

Once a learning content is created, such as a course, the LMS Portal may enable the creator to determine who may enroll in the course, and whether or not the course will be made available to the general public or whether permission will be required to access the course. For example, a course may be tagged as private, controlled, restricted to a given group or entity (e.g., “Human Resources Dept.”), or tagged with some other access setting. Access to a course may require the approval of an administrator of the LMS Portal and/or an administrator of and LMS system accessed through the LMS Portal. An administrator of the LMS Portal may be able to import listings of users to whom permission has been granted, so that each time a user in the listing requests access to a content for which she has permission, the LMS Portal may automatically check the permission stored in a database that is associated with the LMS Portal and grant the user access to the course content. Large groups of user data, including all types of user data and data associated with a user as described herein, may be imported to a database that is associated with the LMS Portal in real time or batch processing (e.g., a .csv file). A user interface may be provided to select the users and/or groups to whom permission to access course content is granted.

In an embodiment, a user may create a course that may be seen in a course catalog that is provided by the LMS Portal, but which requires administrator and/or course-creator approval to obtain or enroll in the course.

In embodiments, a creator of a course may specify at the time of creation, or after the time of creation, if the course is to be made available to users free of charge, or for a fee (i.e., the “fee setting”). Once the fee setting is made, the user may subsequently alter the fee setting. For example, a course creator may experiment with different fee settings in order to optimize a revenue metric (e.g., total revenue, revenue per user, etc.). The optimization of the fee settings may be automated by the LMS Portal using an algorithm that includes the revenue criteria of interest to the user.

In embodiments, registration data fields relating to users of the LMS Portal and/or LCM System may be further associated with metadata, as described herein.

In embodiments, the LMS Portal, and/or the LCM System associated with the LMS Portal, may provide an accountability protocol for use in the administration of LMS Portal users, LCM System users, learning content, test taking, homework, or some other function of the LMS Portal and/or LCM System.

The accountability protocol that is associated with the LMS Portal and/or LCM System may provide for methods and systems for administering test enrollment, test registration, test taking, test help, test grading, test evaluation, or some other functionality that is associated with the administration of tests. In an example embodiment, the accountability protocol may enable a timing mechanism that permits an administrator to monitor the amount of time that a user spends during a test taking session. The timing mechanism may record a duration spent on a page, subset of pages, or all pages of an exam and compare this time duration against a rules engine that is stored on a server that is associated with the LMS Portal and/or LCM System in order to determine an administrative action to take, such as logging a user off of a test if the duration is less than or greater than a predetermined duration. In embodiments, a test creator may determine the permitted time allocations and rules governing a test using the LCM system, and course authoring tools, as described herein.

In embodiments, a creator of a course and/or an administrator may set a minimum amount of time that must be spent on a given test section, and/or a minimum amount of time for which a user may be given credit (e.g., course credit) for interacting with material, such as an exam. A creator of a course and/or an administrator may set a maximum amount of time that can be spent on a given test section. A creator of a course and/or an administrator may set a minimum or maximum time duration allowed for a subset of test sections. A creator of a course and/or an administrator may set a minimum or maximum time duration allowed for an entire test. A creator of a course and/or an administrator may set a minimum or maximum time duration allowed for a plurality of tests. The LMS Portal and/or LCM System may provide the creator of a course and/or an administrator a summary report showing the time durations associated with each portion of an exam. The LMS Portal and/or LCM System may provide a user that took an exam a summary report showing the time durations associated with each portion of an exam.

In embodiments, a creator of a course and/or an administrator may require that a user view every page of an exam (course). Each page view of the exam may be further associated with a required time duration of viewing. The failure of a user to view every page, and/or view every page for an assigned time duration may cause the test to quit, impact test scoring, prompt an alert to an administrator, or precipitate some other activity within the LMS Portal and/or LCM System.

In embodiments, a creator of a course and/or an administrator may use a photographic capability of a client device (e.g., a webcam) through which a user is accessing a learning content, such as a test, in order to verify the user's identity, to confirm that the user is in fact using the client device during the test taking session, to confirm that only one individual is taking a test, or to perform some other visual confirmation regarding the user. In one embodiment, this may be done using Flash. In an example, once a course, test or other learning content is opened by a user, a camera, such as a webcam, may be activated. A window may open on the user's desktop to indicate to the user that he is being filmed and is on screen. The user may then be instructed to take a first photo of himself. A learning content creator and/or administrator may decide how many photographs are taken of the person throughout their interaction with the learning content. The photographs may be cached in the system for an administrator to view at a later time. The photographs may be printed, emailed, and the like, and may be time stamped and/or location stamped (e.g. IP address) as to when and where the learning content was used.

In embodiments, the accountability protocol of the present invention may enable an administrator to provide feedback to a user during interaction with the LMS Portal and/or LCM System, for example, during a test. The accountability protocol may enable the user and the administrator to engage in conversation, for example, about course or test content, using functionality including, but not limited to, SMS, email, phone, video conferencing, or some other means of communication. The communication may be recorded and stored on a server associated with the LMS Portal.

In embodiments, the LMS Portal may be associated with a security facility enabled to scan, analyze, clean, and/or quarantine files and other material that is uploaded to, downloaded from, or interacted with by users within the LMS Portal. The security facility may enable a file type, or plurality of file types, to be restricted, blocked, quarantined, deleted, cleaned, or secured in some other manner, including but not limited to file types such as:
‘php’, ‘php2’, ‘php3’, ‘php4’, ‘php5’, ‘phtml’, ‘pwm1’, ‘inc’, ‘asp’, ‘aspx’, ‘ascx’, ‘jsp’, ‘cfm’, ‘cfc’, ‘pl’, ‘bat’, ‘exe’, ‘com’, ‘dll’, ‘vbs’, ‘js’, ‘reg’, ‘cgi’

In embodiments, the LMS Portal and/or the LCM System may provide uses an interface, method and system for provided feedback, ratings, opinions, and suggestions relating to learning content, courses, tests, or some other type of information available within, or in association with the LMS Portal or LCM System.

In embodiments, data integration techniques and methods may be used as part of the LMS Portal, as described herein, to collect, join, merge, validate, analyze, and perform other data processing operations for LMS data, LMS website data, learning content data, user data, user device data (e.g., applications used to interact with learning content), and other data types as described herein. Data integration techniques and methods may be used to take the information collected from a plurality of LMS data sources in order to draw an inference from the collected information, identifying a potential change to a database based on newly received information, and validating the change to the database based on the inference.

In embodiments, data integration techniques and methods may be used to extract information from a plurality of LMS data sources, and the like, the data sources having a plurality of distinct data types, transforming the data from the data sources into a data type that can be represented in, for example, a database to be used by a LMS Portal, the database thereby integrating information from the distinct data types.

In embodiments the distinct data types may be selected from a group consisting of LMS content data, user data, contextual information relating to learning content, user behavioral information (including user profiles), demographic information, usage history, and other data sources and types as described herein. In embodiments, data integration techniques and methods may be used to apply rules, such as by a rules engine, in connection with creation, updating and maintenance of a data set, such as one stored or used in association with an LMS Portal. A rules engine may be applied to secondary change data, that is, data that comes from one or more data sources and that indicates that a change may be required in a data set or to inference data, that is, data derived by inferences from one or more data sets. For example, a rule may indicate that a change in a data set will be made if a secondary data source confirms an inference, or if an inference is consistent with data indicated by a data source. Similarly, a rule might require multiple confirmations, such as requiring more than one data source or more than one inference before confirming a change to a data set (or creation of a new feature or attribute in the data set). Rules may require any fixed number of confirmations, whether by other data sets or by inferences derived from those data sets. Rules may also embody various processes or work flows, such as requiring a particular person or entity to approve a change of a given type or a change to a particular type of data.

In embodiments, data integration techniques and methods may be used to extract information from a plurality of LMS data sources, the data sources having a plurality of distinct data types, storing the data in a common data set, considering a change request associated with a database, such as a database that is associated with an LMS Portal, and using the common data set to validate the change request.

In embodiments, data integration techniques and methods may be used to extract information from a plurality of LMS data sources, the data sources having a plurality of distinct data types, storing the data in a common data set, considering the common data set to identify potential changes to a database, such as a database that is associated with an LMS Portal, and initiating a change request based on the common data set.

In embodiments, a data integration facility may be used to integrate data from a plurality of LMS data sources, the data sources including attributes relevant to an LMS Portal, wherein the data integration facility is selected from the group consisting of an extraction facility, a data transformation facility, a loading facility, a message broker, a connector, a service oriented architecture, a queue, a bridge, a spider, a filtering facility, a clustering facility, a syndication facility, and a search facility.

In embodiments, a data integration facility may be used to integrate data from a plurality of LMS data sources, taking an inference drawn from analysis of data collected by a plurality of data sources, applying a data integration rule to determine the extent to which to apply the inference, and updating a data set based on the application of the rule.

In embodiments, a data integration facility may be used to integrate data from a plurality of LMS data sources, taking an inference drawn from analysis of data collected by a plurality of data sources, applying a data integration rule hierarchy to determine the extent to which to apply the inference, and updating a data set based on the application of the rule.

In embodiments, a data integration facility may provide a rule hierarchy to determine a data type to use in a data set related to a system, such as an LMS Portal, the rule hierarchy applying a rule based on at least one of a data item, the richness of a data item, the reliability of a data item, the freshness of a data item, and the source of a data item and representing the rule hierarchy in a data integration rule matrix, wherein the matrix facilitates the application of a different rule hierarchy to a different type of data.

In embodiments, a data integration facility may be used to integrate data from a plurality of LMS data sources, taking an inference drawn from analysis of data collected by a data sources, applying a data integration rule matrix to determine the extent to which to apply the inference, and updating a data set based on the application of the rule.

A data integration facility may be used in association with a system, such as an LMS Portal, to iteratively collect and make inferences about data that is collected for use in the LMS Portal. Iteration may be performed a plurality of times, or continuously, as an on-going process to collect and make inferences about data attributes. Iteration may be a function of the entire data set (e.g., an entire learning content usage history of a user), or a function of specific data segments (e.g., learning content usage history <24 hours). Data attributes may be stored for subsequent comparison to previously collected data inference attributes. In embodiments, this process may be continuous, and represent an ongoing comparison of inferred attributes for the purpose of detecting differences over time.

The data integration facility may include at least one of a bridge, a message broker, a queue and a connector. Therefore, a useful data source may be associated with a data integration facility via computer code, hardware, or both, that establishes a connection between the source and the data integration facility. For example, the bridge may include code that takes data in a native data type (such as data in a mark-up language format), extracts the relevant portion of the data, and transforms the data into a different format, such as a format suitable for storing the data for use in an LMS Portal, or by users of the LMS Portal. The message broker may extract data from a data source (e.g., an LMS website), place the data in a queue or storage location for delivery to a target location (e.g., LMS Portal server), and deliver the data at an appropriate time and in an appropriate format for the target location (e.g., to a user of the LMS Portal). In embodiments, the target location may be an LMS Portal database, a data mart, a metadata facility, or a facility for storing or associating an attribute within the LMS Portal. The connector may comprise an application programming interface or other code suitable to connect source and target data facilities, with or without an intermediate facility such as a data mart or a data bag. The connector may, for example, include AJAX code, a SOAP connector, a Java connector, a WSDL connector, or the like.

In embodiments, the data integration facility may be used to integrate data from a plurality of LMS data sources, the data sources including attributes relevant to, for example the LMS Portal. The data integration facility may include a syndication facility. The syndication facility may publish information in a suitable format for further use by computers, services, or the like, such as in aid of creating, updating or maintaining a monetization platform database, such as one related to user behavioral profiles, publishers, or some other type of data used by the LMS Portal, as described herein. For example, the syndication facility may publish relevant data in RSS, XML, OPML or similar format, such as user data, wireless operator data, ad conversion data, publisher data, and many other types of information that may be used by the LMS Portal. The syndication facility may be configured by the data integration facility to feed data directly to a LMS Portal database, such as a user profile database, in order to populate relevant fields of the database with data, to populate attributes of the database, to populate metadata in the database, or the like. In embodiments the syndicated data may be used in conjunction with a rules engine, such as to assist in various inferencing processes, to assist in confirming other data, or the like.

In embodiments, the data integration facility may include a services oriented architecture facility. In the services oriented architecture facility, one or more data integration steps may be deployed as a service that is accessible to various computers and services, including services that assist in the development, updating and maintenance of a LMS Portal database, such as a user profile database, or the like. Services may include services to assist with inferences, such as by implementing rules, hierarchies of rules, or the like, such as to assist in confirmation of data from various sources. Services may be published in a registry with information about how to access the services, so that various data integration facilities may use the services. Access may be APIs, connectors, or the like, such as using Web Services Definition Language, enterprise Java beans, or various other codes suitable for managing data integration in a services oriented architecture.

In embodiments, the data integration facility may include at least one of a spidering facility, a web crawler, a clustering facility, a scraping facility and a filtering facility. The spidering facility, or other similar facility may thus search for data, such as available from various domains, services, LMS operators, publishers, and sources, available on the Internet or other networks, extract the data (such as by scraping or clustering data that appears to be of a suitable type), filter the data based on various filters, and deliver the data, such as to a LMS Portal database. Thus, by spidering relevant data sources, the data integration facility may find relevant data, such as user behavioral data, contextual data relating to content, publisher data, and many other types (of the types variously described herein) of information. The relevant data may be used to draw inferences, to support inferences, to contradict inferences, or the like, with the inference engine, such as to assist in creation, maintenance or updating of an LMS Portal database. The data may also be used to populate data fields directly, to populate attributes associated with data items, or provide metadata.

In embodiments, the present invention may provide a method and system for receiving a query from a client device at an Internet-based learning management system portal, wherein the query relates to learning content subject matter, searching a plurality of learning management systems based at least in part on the received query, and presenting a list of learning content that is relevant to the query, wherein the list enables a user to link to each of the plurality of learning management systems in which a relevant learning content is located. A user of the learning management system portal may access an item of learning content presented within the list and download the item of learning content to the client device.

Accessing an item of learning content using the learning management system portal may require a user to submit a credential to the learning management system portal. A credential may include, but is not limited to, a password, a customer number, a student ID, or some other type of credential.

Accessing an item of learning content may require a user to submit a payment to the learning management system portal. Payment may be automatically deducted from an account that is associated with the learning management system portal.

Accessing an item of learning content may require a user to accept a license term governing the usage of the item of learning content. Concurrent to downloading an item of learning content, an item of sponsored content may be downloaded to the client device. Sponsored content may include, but is not limited to, an advertisement and/or a second item of learning content. The second item of learning content may be relevant to the query. The second item of learning content may be only partially presented to the user and may require that the user make a payment in order for the full second item of learning content to be presented to the user.

In embodiments, a client device may be a personal computer, laptop computer, tablet computer, mobile communication facility, electronic book reading device, television, GPS navigation aid, or some other type of client device. A mobile communication facility may include, but is not limited to, a cellular phone, a GSM phone, a smartphone, or some other type of mobile communication facility.

In embodiments, a query may include, but is not limited to, a keyword, a category, a course name, an instructor's name, an organization name, or some other type of query data.

In embodiments, the relevance of learning content to a query may be based at least in part on contextual data associated with the learning content. Contextual data may include, but is not limited to, a keyword.

In embodiments, the relevance of learning content to a query may be based at least in part on data associated with the user. Data associated with the user may be stored in a user profile. A stored user profile may be associated with a user account that is further associated with the learning management system portal.

In embodiments, a query may be received from a client device at an Internet-based learning management system portal, wherein the query relates to learning content subject matter. Based at least in part on the received query, a plurality of learning management systems may be searched. A list of learning content that is relevant to the query may be presented, wherein the list enables a user to link to each of the plurality of learning management systems in which a relevant learning content is located. The user may access and download a first item of learning content that is presented within the list. The user may access and download a second item of learning content that is presented within the list. The user may combine the first and second items of learning content to create an aggregated item of learning content, and store the aggregated item of learning content on a server that is associated with the learning management system portal.

In embodiments, an aggregated item of learning content may be syndicated to a second user of the learning management system. Syndication may require the second user to make a payment in order to view the aggregated item of learning content. Syndication may combine the aggregated item of learning content with a sponsored content. The learning management system portal may be paid a fee upon each impression of the sponsored content presented to a plurality of users.

In embodiments, a query may be received from a client device at an Internet-based learning management system portal, wherein the query relates to learning content subject matter. Based at least in part on the received query, a plurality of learning management systems may be searched. A list of courses that are relevant to the query may be presented, wherein the list enables a user to link to each of the plurality of learning management systems in which a relevant course is located. The user may access and download a first course that is presented within the list. The user may access and download a second course that is presented within the list. The user may combine the first and second courses to create a curriculum, and store the curriculum on a server that is associated with the learning management system portal.

In embodiments, a curriculum may be syndicated to a second user of the learning management system. Syndication may require the second user to make a payment in order to view the curriculum. Syndication may combine the curriculum with a sponsored content. The learning management system portal may be paid a fee upon each impression of the sponsored content presented to a plurality of users.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed is:

1. A computer-implemented method for locating an item of learning content from a plurality of learning management systems using an Internet-based learning management system portal, the method comprising the steps of:
receiving a query from a client device at an Internet-based learning management system portal, wherein the query relates to learning content subject matter;
searching a plurality of learning management systems based at least in part on the query;
presenting a list of learning content that is relevant to the query to the client device, wherein the list enables a user to link to each of the plurality of learning management systems in which a relevant learning content is located;
accessing an item of learning content presented within the list in response to the user's request; and
enabling the user to view the item of learning content to the client device.

2. Further comprising the computer-implemented method of claim 1, wherein accessing the item of learning content requires a user to submit a credential to the learning management system portal.

3. Further comprising the computer-implemented method of claim 1, wherein accessing the item of learning content requires a user to submit a payment to the learning management system portal.

4. The computer-implemented method of claim 3, wherein the payment is automatically deducted from an account that is associated with the learning management system portal.

5. Further comprising the computer-implemented method of claim 1, wherein concurrent to viewing the item of learning content an item of sponsored content is presented to the client device.

6. The computer-implemented method of claim 1, wherein the client device is a computer.

7. The computer-implemented method of claim 1, wherein the client device is a mobile communication facility.

8. The computer-implemented method of claim 1, wherein the client device is an electronic book reading device (E-Book).

9. The computer-implemented method of claim 1, wherein the client device is a television.

10. The computer-implemented method of claim 1, wherein the relevance of learning content to the query is based at least in part on contextual data associated with the learning content.

11. The computer-implemented method of claim 10, wherein the contextual data is a keyword.

12. The computer-implemented method of claim 1, wherein the relevance of learning content to the query is based at least in part on data associated with the user.

13. The computer-implemented method of claim 12, wherein the data associated with the user is stored in a user profile that is further associated with the learning management system portal.

14. A computer-implemented method for aggregating an item of learning content from a plurality of learning management systems using an Internet-based learning management system portal, the method comprising the steps of:
receiving a query from a client device at an Internet-based learning management system portal, wherein the query relates to learning content subject matter;
searching a plurality of learning management systems based at least in part on the query;
presenting a list of learning content that is relevant to the query to the client device, wherein the list enables a user to link to each of the plurality of learning management systems in which a relevant learning content is located;
accessing a first item of learning content presented within the list in response to the user's first request;
enabling viewing of the first item of learning content on the client device;
accessing a second item of learning content presented within the list in response to the user's second request;
enabling viewing of the second item of learning content on the client device;
combining the first and second items of learning content to create an aggregated item of learning content; and
storing the aggregated item of learning content on a server that is associated with the learning management system portal.

15. Further comprising the computer-implemented method of claim 14, wherein the aggregated item of learning content is syndicated to a second user of the learning management system.

16. The computer-implemented method of claim 15, wherein the syndication requires the second user to make a payment in order to view the aggregated item of learning content.

17. A computer-implemented method for aggregating a curriculum of courses from a plurality of learning management systems using an Internet-based learning management system portal, the method comprising the steps of:
receiving a query from a client device at an Internet-based learning management system portal, wherein the query relates to learning content subject matter;
searching a plurality of learning management systems based at least in part on the query;
presenting a list of courses that are relevant to the query to the client device, wherein the list enables a user to link to each of the plurality of learning management systems in which a relevant course is located;
accessing a first course presented within the list in response to the user's first request;
enabling download of the first course to the client device;
accessing a second course presented within the list in response to the user's second request;
enabling download of the second course to the client device;
combining the first and second courses to create a curriculum; and
storing the curriculum on a server that is associated with the learning management system portal.

18. Further comprising the computer-implemented method of claim 17, wherein the curriculum is syndicated to a second user of the learning management system.

19. The computer-implemented method of claim 18, wherein the syndication combines the curriculum with a sponsored content.

20. The computer-implemented method of claim 19, wherein the learning management system portal is paid a fee upon each impression of the sponsored content presented to a plurality of users.
